(19) United States
(12) Patent Application Publication
(10) Pub. No.: US 2025/0140116 A1
(43) Pub. Date: May 1, 2025

(54) RECOMMENDATION SYSTEM

(71) Applicant: NTT DOCOMO, INC., Tokyo (JP)

(72) Inventors: Yukiko YOSHIKAWA, Chiyoda-ku (JP); Yuki KATSUMATA, Chiyoda-ku (JP); Takuya IZUMISAWA, Chiyoda-ku (JP); Yusuke NAKAMURA, Chiyoda-ku (JP); Tetsuya YAMAGUCHI, Chiyoda-ku (JP)

(73) Assignee: NTT DOCOMO, INC., Tokyo (JP)

(21) Appl. No.: 18/683,653

(22) PCT Filed: Sep. 5, 2022
(86) PCT No.: PCT/JP2022/033319

§ 371 Date: Feb. 14, 2024

(30) Foreign Application Priority Data
Oct. 13, 2021 (JP) 2021-168093

(51) Int. Cl. G08G 1/127; G01C 21/20; G06Q 50/40

(52) U.S. Cl. CPC G08G 1/127; G01C 21/20; G06Q 50/40

(57) ABSTRACT

A recommendation apparatus includes an arrival time prediction unit configured to predict a platform arrival time at which a user will arrive at a boarding bus platform, an extraction unit configured to extract a boarding-scheduled bus arriving at the boarding bus platform after the platform arrival time, a crowdedness degree acquisition unit configured to acquire a crowdedness degree of passengers of the boarding-scheduled bus, and a search unit configured to search for, when the crowdedness degree of the boarding-scheduled bus is equal to or greater than a predetermined degree, as a recommended bus, a bus operating in a boarding section where the user is boardable from any platform among platforms included in a boarding bus stop, arriving at each platform after a possible arrival time as a time at which the user is able to arrive at each platform, and having a crowdedness degree less than the predetermined degree.

### TECHNICAL FIELD

The present invention relates to a recommendation system that recommends to a user a bus to board.

### BACKGROUND ART

A system that, in relation to buses that operate in a predetermined operation section, guides a user to a bus, which operates in a section where users may board, based on an operation schedule set in advance is known. Furthermore, a system that determines a need to transfer passengers from a preceding bus to a succeeding bus based on boarding rates of two or more buses traveling along the same route is known (for example, see Patent Literature 1).

### CITATION LIST

### Patent Literature

[Patent Literature 1] Japanese Unexamined Patent Publication No. 2007-265191

### SUMMARY OF INVENTION

### Technical Problem

On the other hand, passengers crowd into a specific bus vehicle in buses that operate in a predetermined operation section, causing the occurrence of a variation in crowdedness degree between bus vehicles and a disruption in an operation schedule. Furthermore, a user who boards a bus may want to move while avoiding crowdedness even though arrival at a destination is somewhat delayed.

Accordingly, the present invention has been made in view of the above-described problem, and an object of the present invention is to alleviate a variation in crowdedness degree and a disruption in an operation schedule due to crowding of passengers into a specific bus in buses that operate in a predetermined operation section.

### Solution to Problem

To achieve the above-described object, according to an aspect of the present invention, there is provided a recommendation system that recommends to a user a bus to board, in which boarding bus information regarding a boarding section of a bus to be boarded by a user is able to be referred to, the boarding bus information includes information indicating a boarding bus stop and an alighting bus stop as a start point and an end point of the boarding section, and a boarding bus platform as a platform of the boarding-scheduled bus where the user is scheduled to board, among one or more platforms included in the boarding bus stop, and the recommendation system includes an arrival time prediction unit configured to predict a platform arrival time as a time at which the user will arrive at the boarding bus platform, an extraction unit configured to extract a boarding-scheduled bus arriving at the boarding bus platform after the platform arrival time, a crowdedness degree acquisition unit configured to acquire a crowdedness degree of passengers of the boarding-scheduled bus extracted by the extraction unit, a search unit configured to search for, when the crowdedness degree of the boarding-scheduled bus is equal to or greater than a predetermined degree, as a recommended bus, a bus operating in a boarding section where the user is able to board from any platform among the platforms included in the boarding bus stop, arriving at each platform after a possible arrival time as a time at which the user is able to arrive at each platform, and having a crowdedness degree less than the predetermined degree, and a recommendation unit configured to present recommendation information regarding the recommended bus to a terminal of the user.

According to the above-described aspect, the crowdedness degree of the boarding-scheduled bus that arrives at the boarding bus platform after the platform arrival time at which the user arrives at the boarding bus platform is acquired, when the crowdedness degree is equal to or greater than the predetermined degree, a bus that operates in the same boarding section as the boarding-scheduled bus, arrives at each platform after a possible arrival time of the user at the platform of each bus, and has a crowdedness degree less than the predetermined degree is searched as the recommended bus that the user is recommended to board, and the recommendation information regarding the recommended bus is presented in the terminal of the user. Therefore, the user boards the recommended bus presented in the terminal instead of the boarding-scheduled bus, so that crowding of passengers into a specific bus is alleviated. Furthermore, the user can be moved by a bus that has a lower crowdedness degree.

### Advantageous Effects of Invention

It is possible to alleviate a variation in crowdedness degree and a disruption in an operation schedule due to crowding of passengers into a specific bus, in relation to buses that operate in a predetermined operation section.

### BRIEF DESCRIPTION OF DRAWINGS

FIG. 1 is a diagram illustrating an example of an apparatus configuration of a recommendation system of the present embodiment.

FIG. 2 is a block diagram illustrating a functional configuration of a recommendation apparatus of a first embodiment.

FIG. 3 is a hardware block diagram of the recommendation apparatus.

FIG. 4 is a diagram illustrating an example of user information stored in a user information storage unit.

FIG. 5 is a diagram illustrating an example of platform information stored in a bus stop information storage unit, and specifically, an example of information regarding a geo-fence of a platform.

FIG. 6 is a diagram illustrating an example of a configuration of a bus stop and platforms.

FIG. 7 is a diagram illustrating an example of a part of bus information stored in the bus information storage unit.

FIG. 8 is a diagram illustrating an example of a part of bus information stored in the bus information storage unit.

FIG. 9 is a diagram illustrating an example of platform information stored in a bus stop information storage unit, and specifically, an example of information of user-movable platforms.

FIG. 10 is a diagram illustrating an example of movement of the user between platforms.

FIG. 11 is a diagram illustrating a screen example of a terminal where recommendation information is presented.

FIG. 12 is a diagram illustrating a screen example of the terminal where buttons for inputting information of a bus boarded by the user are presented along with recommendation information.

FIG. 13 is a flowchart illustrating processing contents of a recommendation method in the recommendation system.

FIG. 14 is a diagram illustrating a configuration of a recommendation program.

### DESCRIPTION OF EMBODIMENTS

An embodiment of a recommendation system according to the present invention will be described with reference to the drawings. If possible, the same portions are represented by the same reference numerals and description thereof will not be repeated.

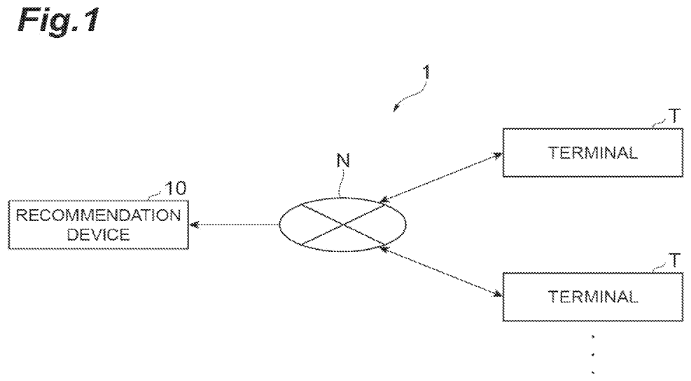

FIG. 1 is a diagram illustrating an apparatus configuration of a recommendation system according to the present embodiment. As illustrated in FIG. 1, a recommendation system 1 includes a recommendation apparatus 10 and terminals T configured to be able to communicate with each other via a network N.

The recommendation apparatus 10 is an apparatus that recommends a user a bus to board. The terminal T is a device that is operated by the user who can be a passenger of the bus. As described below in detail, the terminal T performs acquisition of a position of the terminal, transmission of position information indicating a location to the recommendation apparatus 10, reception of recommendation information from the recommendation apparatus 10, presentation of information regarding a recommended bus indicated in the recommendation information, and the like. An apparatus that configures the terminal T is not limited and may be, for example, a portable terminal such as a high-functioning mobile phone (smartphone), a mobile phone, or a personal digital assistant (PDA). In FIG. 1, two terminals T are illustrated as an example, but the number of terminals T is not limited to the example.

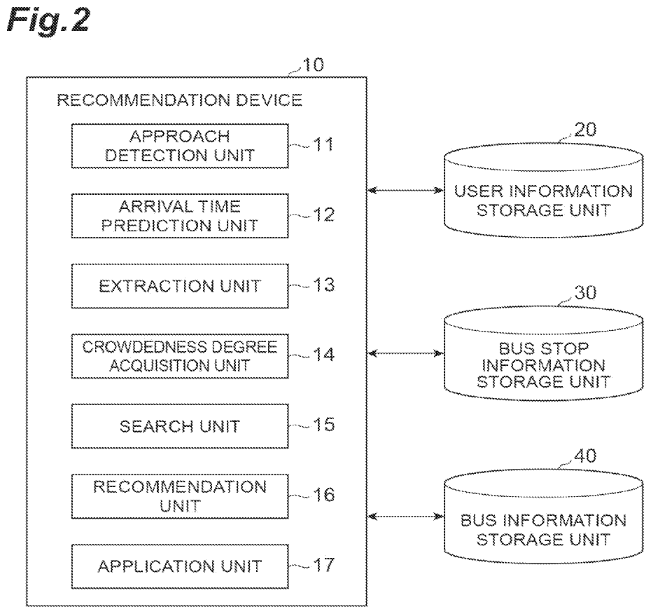

FIG. 2 is a block diagram illustrating an example of a functional configuration of the recommendation apparatus 10. The recommendation apparatus 10 functionally includes an approach detection unit 11, an arrival time prediction unit 12, an extraction unit 13, a crowdedness degree acquisition unit 14, a search unit 15, a recommendation unit 16, and an application unit 17. The functional units 11 to 17 may be configured in one device (a processor, a computer, or the like) or may be distributed among a plurality of devices. Alternatively, one or more functional units among the functional units 11 to 17 may be configured in the terminal T.

The recommendation apparatus 10 is configured to be able to access storage means, such as a user information storage unit 20, a bus stop information storage unit 30, and a bus information storage unit 40. The user information storage unit 20, the bus stop information storage unit 30, and the bus information storage unit 40 may be configured inside the recommendation apparatus 10 or may be configured as a separate device outside the recommendation apparatus 10 to be accessible from the recommendation system as illustrated in FIG. 2.

The block diagram illustrated in FIG. 2 illustrates blocks in units of functions. The functional blocks (configuration units) are implemented by any combination of at least one of hardware and software. Furthermore, the implementation method of each functional block is not particularly limited. That is, each functional block may be implemented using one device combined physically or logically or two or more devices separated physically or logically may be connected directly or indirectly (for example, in a wired or wireless manner) and each functional block may be implemented using the plurality of devices. The functional unit may be implemented by combining software with one device or the plurality of devices.

The functions include determining, deciding, judging, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like, but are not limited thereto. For example, a functional block (configuration unit) that causes transmitting is referred to as a transmitting unit or a transmitter. In any case, as described above, the implementation method is not particularly limited.

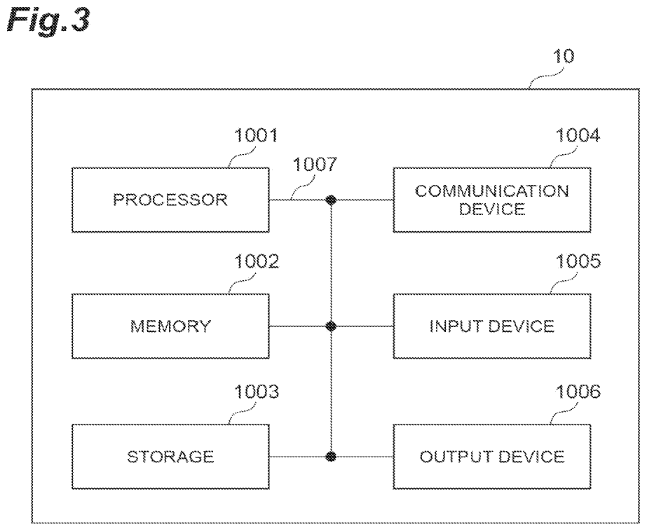

For example, in an embodiment of the present invention, the recommendation apparatus 10 may function as a computer. FIG. 3 is a diagram illustrating an example of a hardware configuration of the recommendation apparatus 10 according to the present embodiment. The recommendation apparatus 10 may be physically configured as a computer apparatus including a processor 1001, a memory 1002, a storage 1003, a communication device 1004, an input device 1005, an output device 1006, a bus 1007, and the like.

In the following description, the terms “apparatus”, “circuit”, “device”, “unit”, and the like can be replaced with each other. The hardware configuration of the recommendation apparatus 10 may be configured to include one or a plurality of devices among the devices illustrated in the drawings or may be configured without including part of the devices.

Each function in the recommendation apparatus 10 is implemented by having the processor 1001 perform an arithmetic operation by reading predetermined software (program) on hardware such as the processor 1001 and the memory 1002, and control communication by the communication device 1004 or at least one of reading and writing of data in the memory 1002 and the storage 1003.

The processor 1001 operates, for example, an operating system to control the entire computer. The processor 1001 may be configured with a central processing unit including an interface with peripheral devices, a control device, an arithmetic unit, a register, and the like. For example, each of the functional units 11 to 17 and the like illustrated in FIG. 2 may be implemented by the processor 1001.

The processor 1001 reads a program (program code), a software module, or data from at least one of the storage 1003 and the communication device 1004 to the memory 1002, and executes various kinds of processing according to the program, the software module, or data. As the program, a program that causes the computer to execute at least a part of the operation described in the above-described embodiment is used. For example, each of the functional units 11 to 17 of the recommendation apparatus 10 may be implemented by a control program that is stored in the memory 1002 and operates in the processor 1001. Although the description has been made that various kinds of processing described above are executed by one processor 1001, various kinds of processing may be executed simultaneously or sequentially by two or more processors 1001. The processor 1001 may be implemented by one or more chips. The program may be transmitted from the network via a telecommunication line.

The memory 1002 is a computer-readable recording medium, and may be configured with at least one of, for example, a read only memory (ROM), an erasable programmable ROM (EPROM), an electrically erasable programmable ROM (EEPROM), and a random access memory (RAM). The memory 1002 may be referred to as a register, a cache, a main memory (main storage device), or the like. The memory 1002 can store a program (program code), a software module, or the like that is executable to perform a recommendation method according to an embodiment of the present invention.

The storage 1003 is a computer-readable recording medium, and may be configured with at least one of, for example, an optical disk such as a compact Disc ROM (CD-ROM), a hard disk drive, a flexible disk, a magneto-optical disk (for example, a compact disk, a digital versatile disk, or a Blu-ray (Registered Trademark) disk), a smart card, a flash memory (for example, a card, a stick, or a key drive), a Floppy (Registered Trademark) disk, and a magnetic strip. The storage 1003 may be referred to as an auxiliary storage device. The above-described storage medium may be, for example, a database, a server, or other appropriate mediums including at least one of the memory 1002 and the storage 1003.

The communication device 1004 is hardware (transmission and reception device) that is provided to perform communication between computers via at least one of a wired network and a wireless network, and is also referred to as, for example, a network device, a network controller, a network card, or a communication module.

The input device 1005 is an input device (for example, a keyboard, a mouse, a microphone, a switch, a button, or a sensor) that receives an input from the outside. The output device 1006 is an output device (for example, a display, a speaker, or an LED lamp) that performs an output to the outside. The input device 1005 and the output device 1006 may be integrated (for example, a touch panel).

The devices such as the processor 1001 and the memory 1002 are connected to the bus 1007 that is provided to communicate information. The bus 1007 may be configured with a single bus or may be configured with different buses between devices.

The recommendation apparatus 10 may be configured to include hardware such as a microprocessor, a digital signal processor (DSP), an application specific integrated circuit (ASIC), a programmable logic device (PLD), or a field programmable gate array (FPGA), and a part or the whole of each functional block may be implemented by such hardware. For example, the processor 1001 may be implemented by at least one of such hardware.

Returning to FIG. 2, the functional units of the recommendation apparatus 10 will be described. The approach detection unit 11 detects that the terminal T of the user approaches a boarding bus platform as a platform of a boarding-scheduled bus that the user is scheduled to board. For the detection, the approach detection unit 11 can refer to a user information storage unit 20 and a bus stop information storage unit 30.

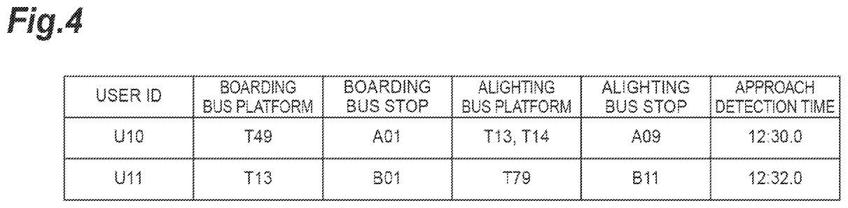

FIG. 4 is a diagram illustrating an example of a configuration of user information stored in the user information storage unit 20. The user information may configure boarding bus information as information regarding a boarding section of a bus to be boarded by the user. The user information includes information such as a boarding bus platform, a boarding bus stop, an alighting bus platform, an alighting bus stop, and an approach detection time, in association with a user ID for identifying the user.

In the present embodiment, a bus stop may include one or more bus platforms. A boarding bus platform is a platform of a boarding-scheduled bus that the user is scheduled to board, among one or more platforms included in a boarding bus stop. An alighting bus platform is a platform where the user is scheduled to alight from the boarding-scheduled bus, among one or more platforms included in an alighting bus stop. The boarding bus platform and the alighting bus platform are a start point and an end point of a boarding section where the user boards the boarding-scheduled bus, respectively.

As illustrated in FIG. 4, a user with a user ID “U10” is scheduled to board a boarding-scheduled bus at a boarding bus platform “T49” included in a boarding bus stop “A01” and to alight from the boarding-scheduled bus at an alighting bus platform “T13, T14” included in an alighting bus stop “A09”.

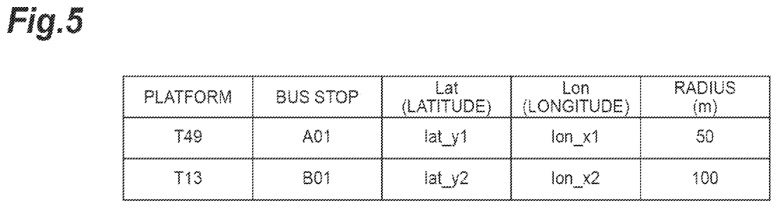

Specifically, the approach detection unit 11 detects the approach of the user to the boarding bus platform based on terminal position information indicating a location of the terminal T and platform position information indicating a location of the boarding bus platform. FIG. 5 is a diagram illustrating an example of platform information stored in the bus stop information storage unit 30, and specifically, an example of information regarding a geo-fence of a platform.

When a geo-fence is set for a platform, the approach detection unit 11 may detect the approach of the user to the boarding bus platform with check-in of the terminal T of the user to the geo-fence of the boarding bus platform. The geo-fence is any virtual geographical boundary or geographical region set with respect to the real world. In the example illustrated in FIG. 5, the platform “T49” included in the bus stop “A01” has a geo-fence made of a circle with a radius of 50 m around latitude “lat_y1” and longitude “lon_x1”. The check-in indicates that the terminal T enters the region of the geo-fence. Specifically, the approach detection unit 11 determines that the terminal T checks in to the geo-fence of the platform “T49” when a distance between a position indicated in the position information of the terminal T received from the terminal T of the user and a position indicated by latitude “lat_y1” and longitude “lon_x1” is within 50 m, and detects that the user approaches the platform “T49”, based on the determination.

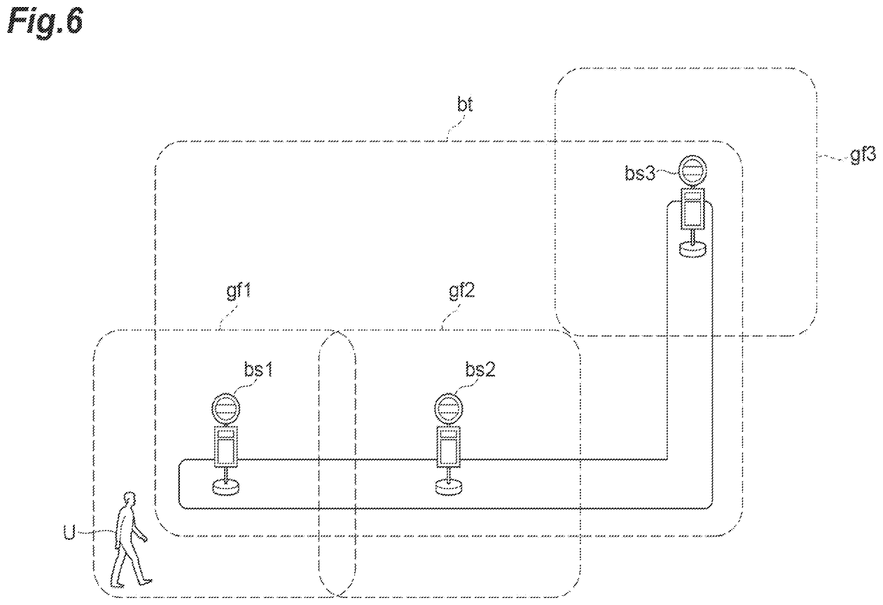

FIG. 6 is a diagram illustrating an example of a configuration of a bus stop and platforms. FIG. 6 illustrates an example of a bus stop bt. The bus stop bt includes platforms bs1, bs2, and bs3. The platform bs1 has a geo-fence gf1. While the geo-fence described with reference to FIG. 5 has a circular shape, the shape of the geo-fence is not limited to the circular shape, and the geo-fence may be a region having any shape, and as illustrated in FIG. 6, may have a rectangular shape. The platform bs2 has a geo-fence gf2. The platform bs3 has a geo-fence gf3. As illustrated in FIG. 6, the approach detection unit 11 detects that a user U approaches the platform bs1 when a terminal T of the user U checks in to a geo-fence gf11.

At the bus stop bt including a plurality of platforms bs1, bs2, and bs3 as illustrated in FIG. 6, when a bus with the platform bs1 as a boarding bus platform is a boarding-scheduled bus of a user, there may be a bus that departs from each of the platforms bs1, bs2, and bs3 and operates in the same section as a boarding section where the user boards the boarding-scheduled bus. The recommendation system 1 of the present embodiment recommends the user a bus satisfying a predetermined condition regarding a distance or a time required for movement of the user between platforms, a crowdedness degree of each bus, or the like as a recommended bus among buses that operate in the same section as the boarding section of the user.

In the present embodiment, although the approach detection unit 11 detects the approach of the terminal T of the user to the boarding bus platform based on the position information of the terminal T and the position information of the boarding bus platform, the present invention is not limited to the method, and the detection may be performed based on, for example, WiFi signals or Beacon signals that are transmitted and received between the terminal T and the boarding bus platform.

The arrival time prediction unit 12 predicts a platform arrival time as a time at which the user will arrive at the boarding bus platform. Specifically, the arrival time prediction unit 12 may predict the platform arrival time when the approach of the terminal T to the boarding bus platform is detected by the approach detection unit 11.

For example, the arrival time prediction unit 12 may predict the platform arrival time by adding a predetermined time set in advance based on the size of the region of the geo-fence to a current time. Alternatively, the arrival time prediction unit 12 may predict the platform arrival time by dividing a distance between the position indicated in the terminal position information and a position indicated in the platform position information by a moving speed of the terminal T. The moving speed of the terminal T may be a predetermined value set in advance or may be a value computed based on a displacement of the position information of the terminal T per unit time.

The arrival time prediction unit 12 may predict the platform arrival time in response to a predetermined instruction input on the terminal T by the user. Alternatively, the arrival time prediction unit 12 may predict the platform arrival time repeatedly at a predetermined time interval after the approach of the terminal T to the boarding bus platform is detected by the approach detection unit 11.

The extraction unit 13 extracts a boarding-scheduled bus that arrives at the boarding bus platform after the platform arrival time of the user. Specifically, the extraction unit 13 extracts information of the boarding-scheduled bus from the bus information storage unit 40.

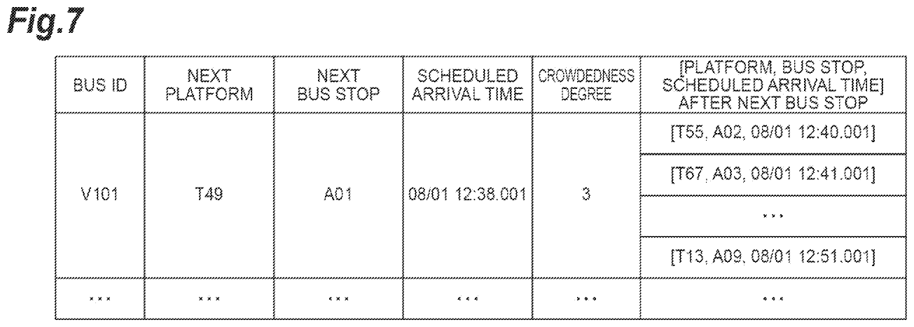

FIG. 7 is a diagram illustrating an example of a part of bus information stored in the bus information storage unit 40. As illustrated in FIG. 7, the bus information includes a next platform, a next bus stop, a scheduled arrival time, crowdedness degree, and a list of a platform, a bus stop, and a scheduled arrival time after the next bus stop, in association with a bus ID for identifying a bus being operated.

The next platform and the next bus stop in the bus information are information of a platform and a bus stop where the bus stops next.

The scheduled arrival time is a scheduled time at which the bus will arrive at the next platform. The scheduled arrival time may be computed by dividing a distance between a position indicated in latest position information of the bus and a position indicated in position information of the next platform by an average speed of the bus and may be stored as bus information. Alternatively, the scheduled arrival time may be acquired based on information indicating an operation schedule of the bus set in advance. The computation and acquisition of the scheduled arrival time may be performed by the recommendation system 1 or may be performed by a system of a company that operates the bus, a supervisor, or the like.

The crowdedness degree is information indicating a degree of abundance of the number of passengers of the bus and may be, for example, a ratio of the number of passengers to the capacity or may be the number of passengers. An acquisition source of the crowdedness degree included in the bus information is not limited, and the crowdedness degree may be acquired from, for example, a system of a company or the like. Alternatively, the crowdedness degree may be computed based on the number of portable terminals of which the position information transits along with transition of position information of the bus.

Information of the platform and the bus stop in the list of the platform, the bus stop, and the scheduled arrival time after the next bus stop may be acquired from, for example, a system of a company of the bus, or the like. The scheduled arrival time at which the bus will arrive at the platform after the next bus stop in the list can be computed or acquired similarly to the scheduled arrival time of the next bus stop described above.

The extraction unit 13 extracts the boarding-scheduled bus that arrives at the boarding bus platform after the platform arrival time of the user, with reference to the bus information as illustrated FIG. 7. For example, when the user “U10” boards the bus at the platform “T49” of the bus stop “A01”, alights from the bus at the platform “T13, T14” of the bus stop “A09”, and the platform arrival time predicted by the arrival time prediction unit 12, at which the user “U10” will arrive at the platform “T49”, is “08/01 12:33.0”, the extraction unit 13 extracts, as the boarding-scheduled bus, a bus “V01” that arrives at the platform “T49” of the bus stop “A01” at time “08/01 12:38.001” after the platform arrival time “08/01 12:33.0” and has a section to the platform “T13” of the bus stop “A09” as an operation section.

Alternatively, the extraction unit 13 may extract, as the boarding-scheduled bus, a bus that arrives at the boarding bus platform within a required time after the platform arrival time. For example, when a bus that arrives at the boarding bus platform within six minutes after the platform arrival time is set to be extracted as the boarding-scheduled bus, the extraction unit 13 extracts, as the boarding-scheduled bus, a bus that arrives at the platform “T49” until time “08/01 12:39.0” six minutes after the platform arrival time “08/01 12:33.0”. Because the bus “V01” is scheduled to arrive at time “08/01 12:38.001”, the extraction unit 13 extracts the bus “V01” as the boarding-scheduled bus.

In this way, an upper limit of a time for which the user waits for the arrival of the boarding-scheduled bus when the user boards the boarding-scheduled bus is set, so that an appropriate boarding-scheduled bus can be extracted.

The crowdedness degree acquisition unit 14 acquires the crowdedness degree of passengers of the boarding-scheduled bus extracted by the extraction unit 13. Specifically, for example, when the crowdedness degree of each bus is stored as bus information in a storage unit such as the bus information storage unit 40, the crowdedness degree acquisition unit 14 acquires the crowdedness degree of the boarding-scheduled bus with reference to the bus information. In the example illustrated in FIG. 7, the crowdedness degree acquisition unit 14 acquires the crowdedness degree “3” of the bus “V01”.

The acquisition of the crowdedness degree may is not limited to the above-described example, and the crowdedness degree acquisition unit 14 may acquire the crowdedness degree by making an inquiry at the system of the company with an identifier such as the bus ID of the boarding-scheduled bus as a key, for example.

The search unit 15 searches for a recommended bus to be recommended to the user when the crowdedness degree of the boarding-scheduled bus is equal to or greater than a predetermined degree. The recommended bus is a bus that operates the boarding section of the user where the user can board from any platform among the platforms included in the boarding bus stop, is predicted to arrive at each platform after a possible arrival time as a time at which the user can arrive at each platform, and has a crowdedness degree less than the predetermined degree. A threshold value regarding the crowdedness degree of the boarding-scheduled bus can be freely set by, for example, the company of the bus and the user.

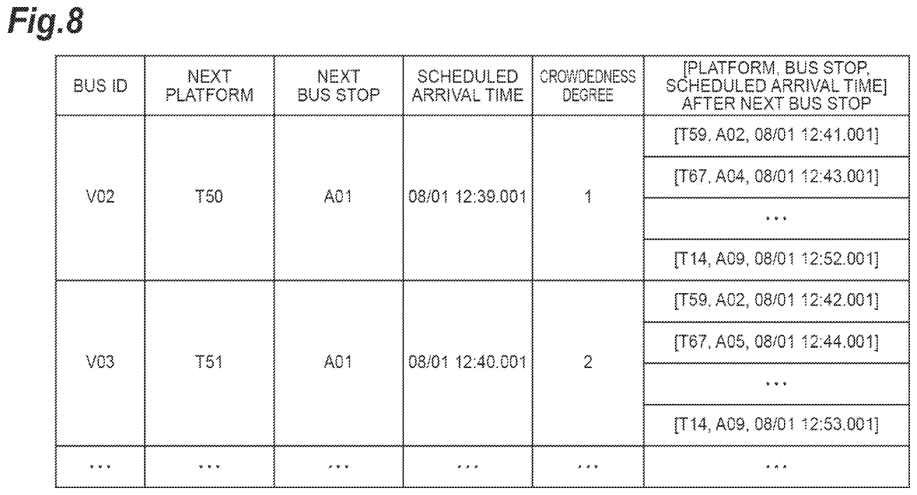

The search unit 15 searches for the recommended bus with reference to, for example, the bus information stored in the bus information storage unit 40. FIG. 8 is a diagram illustrating an example of a part of bus information stored in the bus information storage unit 40. Similarly to the bus information illustrated in FIG. 7, the bus information illustrated in FIG. 8 includes a next platform, a next bus stop, a scheduled arrival time, a crowdedness degree, and a list of a platform, a bus stop, and a scheduled arrival time after the next bus stop, in association with a bus ID for identifying a bus being operated.

For example, if it is assumed that the search for the recommended bus is performed when the crowdedness degree of the boarding-scheduled bus is equal to or greater than “3”, because the crowdedness degree of the boarding-scheduled bus “V01” illustrated in FIG. 7 is 3, the search unit 15 performs the search for the recommended bus.

The search unit 15 sets, as one of search conditions, a condition that a bus is able to boarded by the user from any platform included in the boarding bus stop “A01” and operates in a boarding section from the bus stop “A01” to the bus stop “A09”. That is, the search unit 15 searches for a bus that stops at the bus stop “A01” and includes the bus stop “A09” as a bus stop after the next bus stop.

To set, as one of search conditions, a condition that a bus arrives at each platform after the possible arrival time as a time at which the user can arrive at each platform, the search unit 15 predicts the possible arrival time at each platform.

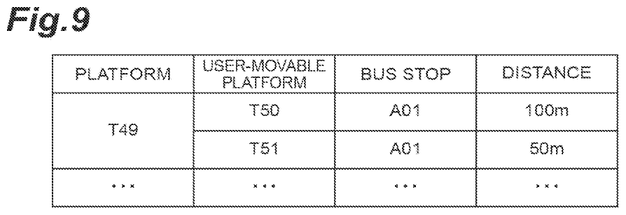

FIG. 9 is a diagram illustrating an example of platform information stored in the bus stop information storage unit 30, and specifically, an example of information of platforms to which the user can move. The platform information illustrated in FIG. 9 illustrates that the user can move from the platform “T49” to platforms “T50” and “T51” included in bus stop “A01”, a distance between the platform “T49” and the platform “T50” is 100 m, and a distance between the platform “T49” and the platform “T51” is 50 m. The distance between the platforms in the bus stop information may be a moving distance along a moving route or may be a direct distance between the platforms.

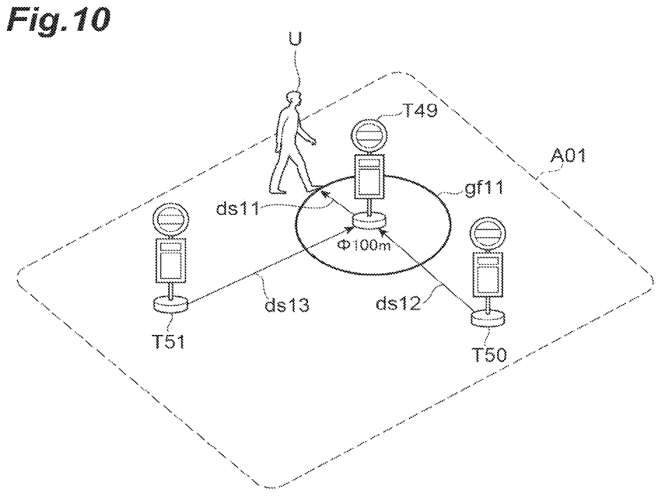

FIG. 10 is a diagram illustrating an example of a positional relationship of platforms for illustrating an example of movement of the user between platforms. FIG. 10 illustrates, as an example, a state in which the time the user U checks in to the platform “T49”.

The search unit 15 computes a necessary time to the platform “T50”, for example, by dividing a distance obtained by adding a distance ds12 between the platform “T49” and the platform “T50” to a distance ds11 between the terminal T of the user U and the platform “T49” by the moving speed of the user U and the terminal T, and computes a possible arrival time at the platform “T50” by adding the computed necessary time to the current time (for example, the time at which the user U checks in to the geo-fence gf11 of the platform “T49”).

Similarly, the search unit 15 computes a necessary time to the platform “T51”, for example, by dividing a distance obtained by adding a distance ds13 between the platform “T49” and the platform “T51” to the distance ds11 between the terminal T of the user U and the platform “T49” by the moving speed of the user U and the terminal T, and computes a possible arrival time at the platform “T51” by adding the computed necessary time to the current time (for example, the time at which the user U checks in to the geo-fence gf11 of the platform “T49”).

If it is assumed that the possible arrival time at the platform “T50” is, for example, “08/01 12:36.0”, the search unit 15 sets, as a search condition, a condition that a bus arrives at the platform “T50” after the possible arrival time “08/01 12:36.0”. Furthermore, if it is assumed that the possible arrival time at the platform “T51” is, for example, “08/01 12:35.0”, the search unit 15 sets, as a search condition, a condition that a bus arrives at the platform “T51” after the possible arrival time “08/01 12:35.0”.

The search unit 15 may search for a bus that arrives at each platform within a required time after the possible arrival time. The required time in the search condition can be freely set by the company of the bus, an operator of the recommendation system, the user, or the lie. For example, when a condition that a bus arrives at each platform within six minutes after the possible arrival time is set as a search condition, the search unit 15 sets, as a search condition, a condition that a bus arrives at the platform “T50” after the possible arrival time “08/01 12:36.0” and before time “08/01 12:42.0”. Furthermore, the search unit 15 sets, as a search condition, a condition that a bus arrives at the platform “T51” after the possible arrival time “08/01 12:35.0” and before time “08/01 12:41.0”. By searching for a recommended bus under such a search condition, when the user selects to board the recommended bus, the upper limit of the time for which the user waits for the recommended bus is set. As a result, a bus can be recommended in consideration of convenience for the user can be made.

The search unit 15 sets, as a search condition for a recommended bus, a condition that the crowdedness degree is less than the predetermined degree. For example, when a condition that the crowdedness degree represented by an integer is less than 3 is set, the search unit 15 searches for a recommended bus under a search condition that the crowdedness degree is equal to or less than 2.

The search unit 15 extracts, as a recommended bus, a bus “V02” that stops at the platform “T50” of the bus stop “A01”, includes the bus stop “A09” and the platform “T14” as the bus stop and the platform after the next bus stop, sets time “08/01 12:39.001” after the possible arrival time “08/01 12:36.0” of the user at the platform “T50” as a scheduled arrival time, and has a crowdedness degree of “1”, based on the above-described search condition with reference to the bus information illustrated in FIG. 8.

Furthermore, the search unit 15 extracts, as a recommended bus, a bus “V03” that stops at the platform “T51” of the bus stop “A01”, includes the bus stop “A09” and the platform “T14” as the bus stop and the platform after the next bus stop, sets time “08/01 12:40.001” after the possible arrival time “08/01 12:35.0” of the user at the platform “T51” as a scheduled arrival time, and has a crowdedness degree of “2”, based on the same search condition.

The search unit 15 may search for a recommended bus under a condition that a bus is able to be boarded by the user from a platform, which as a distance or a moving time from the boarding bus platform is within a required distance or a required time, among the platforms included in the boarding bus stop, as a further search condition. In this way, the upper limit is set for the distance or the time required for the user to move to the platform for boarding the recommended bus, so that labor and burden on the user for boarding the recommended bus are reduced.

Returning to FIG. 2, the recommendation unit 16 presents recommendation information regarding the recommended bus to the terminal T. Specifically, the recommendation unit 16 transmits information of, for example, the platform of the recommended bus and the time, at which the recommended bus arrives at the platform, as recommendation information to the terminal T of the user. The terminal T displays the received recommendation information on, for example, a display of the terminal T.

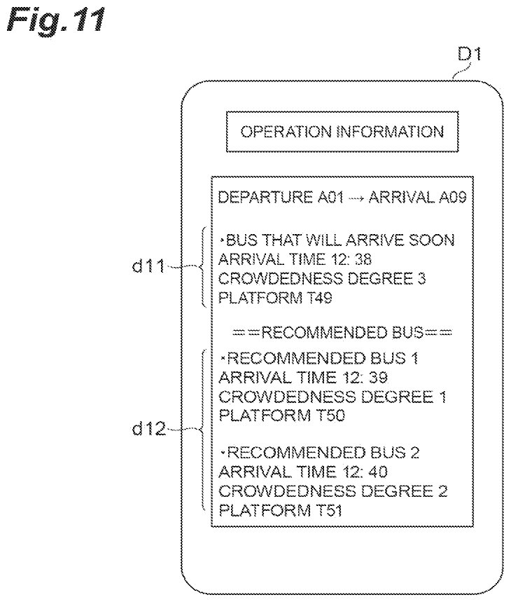

FIG. 11 is a diagram illustrating a display screen example of the terminal T where recommendation information is presented. As illustrated in FIG. 11, the recommendation unit 16 displays the recommendation information on a display screen D1 of the terminal T. The display screen D1 displays recommendation information d11 and d12. The recommendation information d11 is information regarding the boarding-scheduled bus and includes information of the arrival time, the crowdedness degree, and the platform of the boarding-scheduled bus. The recommendation information d12 is information regarding the recommended bus and includes information of the arrival time, the crowdedness degree, and the platform of the bus “V02” searched as the recommended bus. Furthermore, the recommendation information d12 includes information of the arrival time, the crowdedness degree, and the platform of the bus “V03” searched as the recommended bus. The user can consider boarding the recommended bus instead of the boarding-scheduled bus with reference to the recommendation information displayed on the display screen D1 of the terminal T.

Returning to FIG. 2, the application unit 17 determines application of an incentive to the user when the user boards the recommended bus. While an aspect of the incentive is not limited, for example, the application unit 17 may determine application of points to the user or may determine return of a boarding fare to the user.

Specifically, the application unit 17 may transmit incentive information indicating the application of the incentive to the user, to the terminal T of the user. Furthermore, the application unit 17 may store the incentive information in a predetermined database that manages information of the incentive, in association with the user.

The application unit 17 can determine that the user boards the recommended bus, using various methods, and the determination method is not limited. For example, the application unit 17 may determine that the user boards the recommended bus when a distance between recommended bus position information indicating a location of the recommended bus and the terminal position information indicating the location of the terminal T is within a required distance for a predetermined time or more after the recommended bus arrives at the boarding bus stop. The application unit 17 may acquire the recommended bus position information from, for example, the system of the company that operates the bus or a communication terminal mounted on the bus. Furthermore, the application unit 17 may acquire the terminal position information from the terminal T of the user.

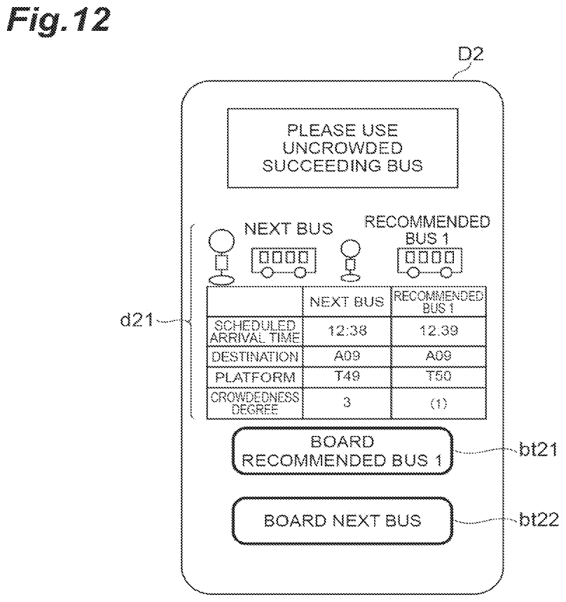

The application unit 17 may determine that the user boards the recommended bus when information indicating the user boards the recommended bus is input in the terminal T. FIG. 12 is a diagram illustrating a screen example of the terminal T where buttons for inputting information indicating that the user boards the recommended bus are presented along with recommendation information. A display screen D2 illustrated in FIG. 12 displays recommendation information d21 and buttons bt21 and bt22.

The recommendation information d21 includes information of the scheduled arrival times, the bus stops and the platforms of destinations, and the crowdedness degrees of the boarding-scheduled bus and the recommended bus.

The button bt21 is an object that causes the user to perform an input operation when the user boards the recommended bus. When the user performs an input operation on the button bt21, information indicating that the input operation is performed is transmitted from the terminal T, and the application unit 17 can determine that the user boards the recommended bus.

The button bt22 is an object that causes the user to perform an input operation when the user boards the boarding-scheduled bus. When the user performs an input operation on the button bt22, information indicating that the input operation is performed is transmitted from the terminal T, and the application unit 17 can determine that the user boards the boarding-scheduled bus.

FIG. 10 is a flowchart illustrating processing contents of a recommendation method in the recommendation apparatus 10.

In Step S1, the approach detection unit 11 determines whether or not the approach of the terminal T of the user to the boarding bus platform as the platform of the boarding-scheduled bus that the user is scheduled to board is detected. When the approach of the terminal T of the user to the boarding bus platform is detected, the process proceeds to Step S2. On the other hand, when the approach of the terminal T of the user to the boarding bus platform is not detected, the detection processing of Step S1 is repeated.

In Step S2, the extraction unit 13 extracts the boarding-scheduled bus that arrives at the boarding bus platform after the platform arrival time as the time at which the user arrives at the boarding bus platform. The platform arrival time is predicted by the arrival time prediction unit 12.

In Step S3, the crowdedness degree acquisition unit 14 acquires the crowdedness degree of the boarding-scheduled bus extracted in Step S2 and determines whether or not the crowdedness degree is equal to or greater than the predetermined degree. When determination is made that the crowdedness degree of the boarding-scheduled bus is equal to or greater than the predetermined degree, the process proceeds to Step S4. On the other hand, when determination is not made that the crowdedness degree of the boarding-scheduled bus is equal to or greater than the predetermined degree, the process proceeds to Step S7.

In Step S4, the search unit 15 searches for the recommended bus satisfying a predetermined condition for making a recommendation to the user. The recommended bus is a bus that operates in the boarding section of the user where the user can board from any platform among the platforms included in the boarding bus stop, is predicted to arrive at each platform after the possible arrival time as the time at which the user can arrive at each platform, and has the crowdedness degree less than the predetermined degree.

In Step S5, the search unit 15 determines whether or not the recommended bus satisfying the predetermined condition is searched. When determination is made that the recommended bus is searched, the process proceeds to Step S6. On the other hand, when determination is not made that the recommended bus is searched, the process proceeds to Step S7.

In Step S6, the recommendation unit 16 transmits the recommendation information regarding the recommended bus to the terminal T and presents the recommendation information to the terminal T. The recommendation information includes information of the platform of the recommended bus and the time at which the recommended bus arrives at the platform.

On the other hand, in Step S7, the recommendation unit 16 transmits information of the boarding-scheduled bus to the terminal T.

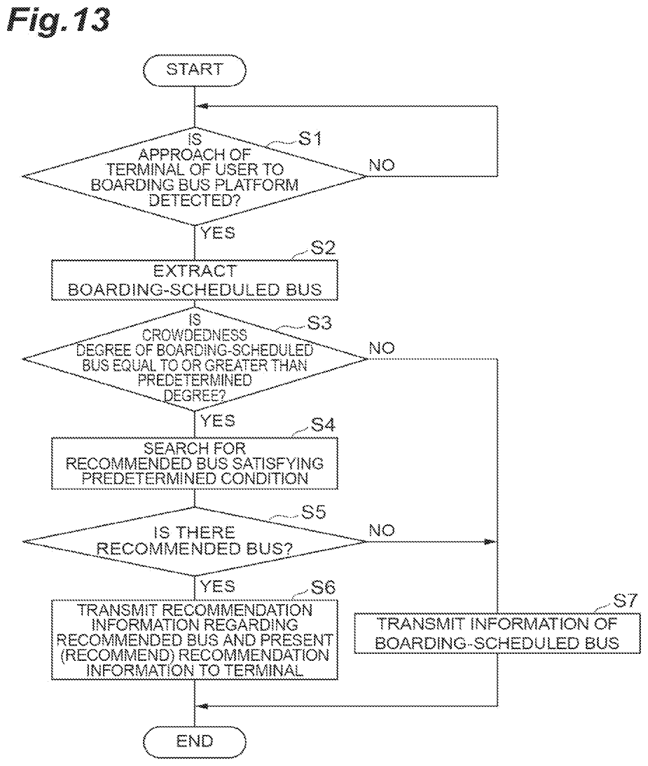

While recommendation processing illustrated in the flowchart of FIG. 13 is executed in response to the approach of the terminal T of the user to the boarding bus platform, the recommendation processing may be executed repeatedly, for example, at a predetermined time interval during a period in which the terminal T of the user stays in a range within a predetermined distance from the boarding bus platform, that is, when a state in which the user approaches the boarding bus platform is continued.

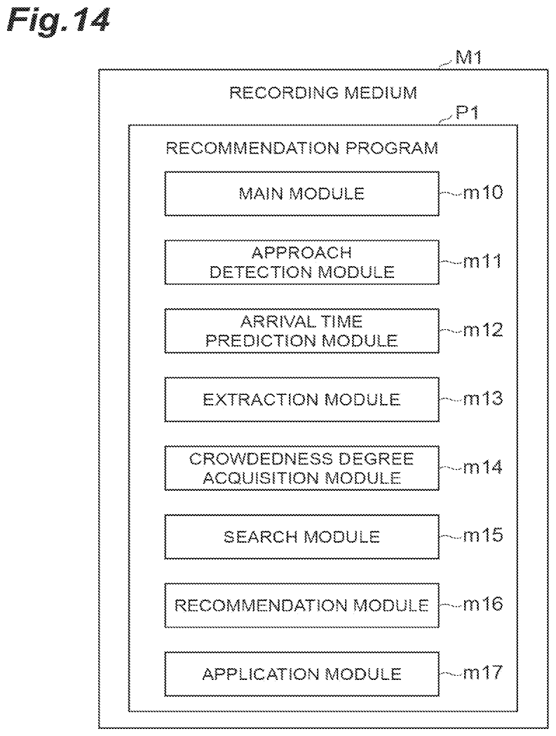

Next, a recommendation program that causes a computer to function as the recommendation apparatus 10 of the present embodiment will be described with reference to FIG. 14.

FIG. 14 is a diagram illustrating a configuration of a recommendation program. A recommendation program P1 is configured to include a main module m10 that integrally controls the recommendation processing in the recommendation apparatus 10, an approach detection module m11, an arrival time prediction module m12, an extraction module m13, a crowdedness degree acquisition module m14, a search module m15, a recommendation module m16, and an application module m17. Then, the functions for the approach detection unit 11, the arrival time prediction unit 12, the extraction unit 13, the crowdedness degree acquisition unit 14, the search unit 15, the recommendation unit 16, and the application unit 17 are implemented by the modules m11 to m17, respectively.

The recommendation program P1 may be transmitted via a transmission medium such as a communication line or may be stored in a recording medium M1 as illustrated in FIG. 14.

According to the recommendation apparatus 10, the recommendation method, and the recommendation program P1 of the present embodiment described above, the crowdedness degree of the boarding-scheduled bus that arrives at the boarding bus platform after the platform arrival time at which the user arrives at the boarding bus platform is acquired, when the crowdedness degree is equal to or greater than the predetermined degree, the bus that operates in the same boarding section as the boarding-scheduled bus, arrives at each platform after the possible arrival time of the user at the platform of each bus, and has the crowdedness degree less than the predetermined degree is searched as the recommended bus that the user is recommended to board, and the recommendation information regarding the recommended bus is presented in the terminal of the user. Therefore, the user boards the recommended bus presented in the terminal instead of the boarding-scheduled bus, so that crowding of passengers to a specific bus is alleviated. Furthermore, the user can move by a bus with a lower crowdedness degree.

A recommendation system according to another aspect may further include an approach detection unit configured to detect that the terminal of the user approaches the boarding bus platform, based on terminal position information indicating a location of the terminal and platform position information indicating a location of the boarding bus platform, and the arrival time prediction unit may be configured to predict the platform arrival time when the approach of the terminal to the boarding bus platform is detected.

According to the above-described aspect, when the approach of the terminal of the user to the boarding bus platform is detected based on the terminal position information and the platform position information, the platform arrival time of the user is predicted, and the search of the recommended bus and the presentation of the recommendation information to the terminal are performed based on the predicted platform arrival time. Therefore, information of the recommended bus can be recommended to the user at an appropriate timing.

In a recommendation system according to another aspect, the arrival time prediction unit may be configured to predict the platform arrival time when a predetermined instruction input on the terminal by the user is performed.

According to the above-described aspect, the platform arrival time is predicted in response to the predetermined instruction input on the terminal, and the search of the recommended bus and the presentation of the recommendation information to the terminal are performed based on the predicted platform arrival time. Therefore, the user can receive the recommendation of the recommended bus at any timing.

In a recommendation system according to another aspect, the search unit may be configured to search for a bus that arrives at each platform within a required time after the possible arrival time.

According to the above-described aspect, when the user selects to board the recommended bus, the upper limit of the time for which the user waits for the recommended bus is set. Therefore, a bus can be recommended in consideration of convenience for the user can be made.

In a recommendation system according to another aspect, the extraction unit may be configured to extract, as the boarding-scheduled bus, a bus that arrives at the boarding bus platform within a required time after the platform arrival time.

According to the above-described aspect, the upper limit of the time for which the user waits for the boarding-scheduled bus when the user boards the boarding-scheduled bus is set. Therefore, an appropriate boarding-scheduled bus can be extracted.

A recommendation system according to another aspect may further include an application unit that determines application of an incentive to the user when the user boards the recommended bus.

According to the above-described aspect, when the user selects to board the recommended bus instead of the boarding-scheduled bus, the incentive is applied to the user, and as a result, the user is prompted to use the recommended bus. Therefore, crowding of passengers in the boarding-scheduled bus is alleviated.

In a recommendation system according to another aspect, the application unit may be configured to determine that the user has boarded the recommended bus when a distance between recommended bus position information indicating a location of the recommended bus and terminal position information indicating a location of the terminal is within a required distance or when information indicating that the user boards the recommended bus is input in the terminal, for a predetermined time or more after the recommended bus arrives at the boarding bus stop.

According to the above-described aspect, the recommendation system can recognize that the user reliably boards the recommended bus.

In a recommendation system according to another aspect, the search unit may be configured to search for, as the recommended bus, a bus that is able to be boarded by the user from a platform, which has a distance or a moving time from the boarding bus platform within a required distance or a required time, among the platforms included in the boarding bus stop.

According to the above-described aspect, the upper limit is set for the distance or the time required for the user to move to the platform where the user boards the recommended bus. Therefore, labor and burden on the user for boarding the recommended bus are reduced.

Although the present embodiment has been described in detail above, it will be apparent to those skilled in the art that the present embodiment is not limited to the embodiments described in the present specification. The present embodiment can be implemented as modified and changed aspects without departing from the spirit and scope of the present invention defined by the description of the claims. Therefore, the description of the present specification is intended for illustration and does not have any restrictive meaning with respect to the present embodiment.

Each aspect/embodiment described in the present specification may be applied to a system using long term evolution (LTE), LTE-Advanced (LTE-A), SUPER 3G, IMT-Advanced, 4G, 5G, future radio access (FRA), W-CDMA (Registered Trademark), GSM (Registered Trademark), CDMA2000, ultra mobile broadband (UMB), IEEE 802.11 (Wi-Fi), IEEE 802.16 (WiMAX), IEEE 802.20, Ultra-WideBand (UWB), Bluetooth (Registered Trademark), or other appropriate systems and/or a next generation system extended based thereon.

A process procedure, a sequence, a flowchart, and the like in each aspect/embodiment described in the present specification may be in a different order unless inconsistency arises. For example, for the method described in the present specification, elements of various steps are presented in an exemplary order, and the elements are not limited to the presented specific order.

Input or output information or the like may be stored in a specific place (for example, a memory) or may be managed in a management table. Information or the like to be input or output can be overwritten, updated, or additionally written. Output information or the like may be deleted. Input information or the like may be transmitted to another device.

Determination may be performed using a value (0 or 1) represented by one bit, may be performed using a Boolean value (true or false), or may be performed through numerical value comparison (for example, comparison with a predetermined value).

Each aspect/embodiment described in the present specification may be used alone, may be used in combination, or may be switched according to implementation. Furthermore, notification of predetermined information (for example, notification of “being X”) is not limited to explicit notification, but may be performed by implicit notification (for example, not performing notification of the predetermined information).

While the present disclosure has been described above in detail, it will be apparent to those skilled in the art that the present disclosure is not limited to the embodiments described in the present disclosure. The present disclosure may be implemented as modified and changed aspects without departing from the spirit and scope of the present disclosure defined by the description in the claims. Therefore, the description in the present disclosure is for illustration and does not have any restrictive meaning with respect to the present disclosure.

Regardless of whether software is called software, firmware, middleware, microcode, or hardware description language or is called another name, software should be construed widely to mean an instruction, an instruction set, a code, a code segment, a program code, a program, a sub-program, a software module, an application, a software application, a software package, a routine, a sub-routine, an object, an executable file, a thread of execution, a procedure, a function, and the like.

Furthermore, software, commands, and the like may be transmitted and received via a transmission medium. For example, when software is transmitted from a website, a server, or another remote source using wired technology such as a coaxial cable, an optical fiber cable, a twisted pair, or a digital subscriber line (DSL) and/or wireless technology such as infrared rays, no cable, or microwaves, the wired technology and the wireless technology are included in the definition of the transmission medium.

Information, signals, and the like described in the present disclosure may be represented using any of various technologies. For example, data, an instruction, a command, information, a signal, a bit, a symbol, and a chip that can be referred to throughout the above description may be represented by a voltage, a current, an electromagnetic wave, a magnetic field or a magnetic particle, a photo field or a photon, or any combination thereof.

Terms described in the present disclosure and terms for understanding the present specification may be substituted with terms having the same or similar meanings.

The terms “system” and “network” used in the present specification may be used interchangeably.

Information, parameters, and the like described in the present specification may be represented by absolute values, may be represented by relative values from predetermined values, or may be represented using other corresponding information.

The term “determining” used in the present disclosure may include a variety of operations. The term “determining” may include, for example, considering judging, calculating, computing, processing, deriving, investigating, searching (looking up, search, or inquiry) (for example, looking up in a table, a database, or another data structure), or ascertaining as “determining”. Furthermore, the term “determining” may include considering receiving (for example, receiving information), transmitting (for example, transmitting information), input, output, or accessing (for example, accessing data in a memory) as “determining”. Moreover, the term “determining” may include considering resolving, selecting, choosing, establishing, comparing, or the like as “determining”. That is, the term “determining” may include considering a certain operation as “determining”. Furthermore, the term “determining” may be replaced with “assuming”, “expecting”, “considering”, or the like.

The expression “based on” used in the present disclosure does not mean “based on only” unless otherwise described. In other words, the expression “based on” means both “based on only” and “based on at least”.

No reference to elements named with “first”, “second”, and the like used in the present specification generally limit an amount or order of the elements. These namings may be used in the present specification as a convenient method for distinguishing between two or more elements. Therefore, reference to first and second elements does not mean that only two elements are employed or that a first element precedes a second element in any form.

As long as the terms “include”, “including”, and modifications thereof are used in the present specification or the claims, these terms are intended to be comprehensive similarly to the term “comprising”. In addition, the term “or” used in the present specification or the claims is intended not to be an exclusive OR.

In the present specification, it is assumed that a plurality of devices are also included unless the context or technical constraints clearly indicate that only one device is present.

In the entire present disclosure, it is assumed that a plurality of things are included unless the context clearly indicates a singular thing.

### REFERENCE SIGNS LIST

1 Recommendation system
10 Recommendation apparatus
11 Approach detection unit
12 Arrival time prediction unit
13 Extraction unit
14 Crowdedness degree acquisition unit
15 Search unit
16 Recommendation unit
17 Application unit
20 User information storage unit
30 Bus stop information storage unit
40 Bus information storage unit
M1 Recording medium
m10 Main module
m11 Approach detection module
m12 Arrival time prediction module
m13 Extraction module
m14 Crowdedness degree acquisition module
m15 Search module
m16 Recommendation module
m17 Application module
P1 Recommendation program
T Terminal

1. A recommendation system that recommends to a user a bus to board,
wherein boarding bus information regarding a boarding section of a bus to be boarded by the user is able to be referred to,
the boarding bus information includes information indicating a boarding bus stop and an alighting bus stop as a start point and an end point of the boarding section, and a boarding bus platform as a platform of the boarding-scheduled bus where the user is scheduled to board, among one or more platforms included in the boarding bus stop, and
the recommendation system comprises:
an arrival time prediction unit configured to predict a platform arrival time as a time at which the user will arrive at the boarding bus platform;
an extraction unit configured to extract a boarding-scheduled bus arriving at the boarding bus platform after the platform arrival time;
a crowdedness degree acquisition unit configured to acquire a crowdedness degree of passengers of the boarding-scheduled bus extracted by the extraction unit;
a search unit configured to search for, when the crowdedness degree of the boarding-scheduled bus is equal to or greater than a predetermined degree, as a recommended bus, a bus operating in a boarding section where the user is able to board from any platform among the platforms included in the boarding bus stop, arriving at each platform after a possible arrival time as a time at which the user is able to arrive at each platform, and having a crowdedness degree less than the predetermined degree; and
a recommendation unit configured to present recommendation information regarding the recommended bus to a terminal of the user.

2. The recommendation system according to claim 1, further comprising:
an approach detection unit configured to detect that the terminal of the user approaches the boarding bus platform, based on terminal position information indicating a location of the terminal and platform position information indicating a location of the boarding bus platform,
wherein the arrival time prediction unit is configured to predict the platform arrival time when the approach of the terminal to the boarding bus platform is detected.

3. The recommendation system according to claim 1,
wherein the arrival time prediction unit is configured to predict the platform arrival time when a predetermined instruction input on the terminal by the user is performed.

4. The recommendation system according to claim 1,
wherein the search unit is configured to search for a bus that arrives at each platform within a required time after the possible arrival time.

5. The recommendation system according to claim 1,
wherein the extraction unit is configured to extract, as the boarding-scheduled bus, a bus that arrives at the boarding bus platform within a required time after the platform arrival time.

6. The recommendation system according to claim 1, further comprising:
an application unit configured to determine application of an incentive to the user when the user boards the recommended bus.

7. The recommendation system according to claim 6,
wherein the application unit is configured to determine that the user has boarded the recommended bus when a distance between recommended bus position information indicating a location of the recommended bus and terminal position information indicating a location of the terminal is within a required distance or when information indicating that the user boards the recommended bus is input in the terminal, for a predetermined time or more after the recommended bus arrives at the boarding bus stop.

8. The recommendation system according to claim 1,
wherein the search unit is configured to search for, as the recommended bus, a bus that is able to be boarded by the user from a platform, which has a distance or a moving time from the boarding bus platform within a required distance or a required time, among the platforms included in the boarding bus stop.

9. The recommendation system according to claim 2,
wherein the search unit is configured to search for a bus that arrives at each platform within a required time after the possible arrival time.

10. The recommendation system according to claim 3,
wherein the search unit is configured to search for a bus that arrives at each platform within a required time after the possible arrival time.
